(19) United States
(12) Patent Application Publication
(10) Pub. No.: US 2019/0344506 A1
(43) Pub. Date: Nov. 14, 2019

(54) Three-Dimensional Printing Method for Producing a Product Protected Against Forgery by Means of a Security Feature

(71) Applicant: U-NICA Technology AG, Malans (CH)

(72) Inventor: Klaus Franken, Igis (CH)

(21) Appl. No.: 16/071,224

(22) PCT Filed: Dec. 6, 2016
(86) PCT No.: PCT/EP2016/079888

§ 371 Date: Jul. 19, 2018

(30) Foreign Application Priority Data
Dec. 8, 2015 (EP) 15198513.2

(51) Int. Cl. B29C 64/386; B33Y 50/02; G05B 19/4099

(52) U.S. Cl. CPC B29C 64/386; B29C 64/118; G05B 19/4099; B33Y 50/02

(57) ABSTRACT

The invention relates to a three-dimensional printing method for producing a product (1c) protected against forgery by means of at least one first security feature (3). Said method provides a digital 3D model of the product to be created, in addition to positions for the at least one feature material for the at least one security feature and the digital model as a program code for controlling a 3D printer. A print or layered structure of the product is then created with the predetermined materials (14a, 134) and the feature materials in the positions provided and the product is removed from the production facility and prepared for the defined use thereof.

### TECHNICAL FIELD

The present invention relates to a three-dimensional printing method for the production of a product which is protected against forgery with at least one first security feature, having the following method steps: providing a digital 3D model of the product to be created, providing the positions for the at least first feature substance for the at least first security feature, providing the digital model as a program code for controlling a 3D printer, providing at least one first predetermined material for the 3D print, providing at least one second predetermined material from the at least one feature substance or containing the latter, printing the product or building it up in layer-wise fashion with the at least one first predetermined material, making available the at least one feature substance at the intended positions, and removing the product from the manufacturing facility or working space of the 3D printer and preparing for the intended use.

### PRIOR ART

A method of this type is known from WO 2011/131475 or also from EP 2 837 444.

Products are increasingly produced from polymer materials, or the proportion of polymer materials in products continuously increases to the detriment of materials of sustainable value, such as metals or woods, for example. Typical production methods are optimized for mass production, while the complexity of a polymer product such as for example an instrument panel part for a vehicle can here be very great. Production processes of high-value goods become cheaper in this way, but at the cost of flexibility with respect to small quantities.

The subject matter of novel production methods is the attempt to adequately fulfill demands in terms of quantity flexibility, quality and complexity with low unit costs.

Known from the prior art are additive manufacturing methods, or 3D printing. Accordingly, the market of the products produced by way of what is known as 3D printing methods is increasing explosively, while permanent development for sometimes highly cost-effective devices and for semi-professional and industrial application is taking place. The industrial applications are diverse even today, although 3D printing methods (also generative or additive manufacturing methods) currently still operate at relatively low speeds (10 to 20 cm³/h). In the next few years, a multiple of this value should be expected.

The methods which are most suitable for small series or even individual pieces are characterized by extraordinary flexibility with respect to the product form. Typical products are specially adapted, partially complex-shaped small parts such as cable holders (EP 2 642 625), cooling bodies (EP 2 808 986) or camera adapters for special tripod heads (EP 2 679 878), device components such as for a tinnitus noiser (EP 2 870 949), dental moldings (EP 1 652 491) or molds e.g. for spectacle lenses (EP 2 868 461). The applications are conceivable practically in any desired fashion. For example, device components which are no longer available, such as switches for vintage cars, are made available, or entire organs made of printed tissue can be built.

On the other hand, the problem of efficiently and economically protecting high-value plastic products in small quantities against forgery arises. The well-known disadvantages relating to products of the counterfeiting industry, i.e. potentially poor quality due to low-quality base materials or greater manufacturing tolerances, loss of revenue, loss of warranty etc. affect both consumers and manufacturers. 3D scanners simplify counterfeiting attempts when the external shape of an original product is scanned and a digital model over the outer surface of such a product is produced. With such a model it is then possible, using 3D print, to produce a counterfeit product which is deceptively realistic both visually and in terms of touch. However, the correct function of a product is decided not only by the external shape, but also by e.g. the embodiment of the inner surfaces. Especially in the case of products which are produced using additive methods, it is the option of designing the inner surfaces which is the reason for selecting such a method. Increasing product complexity and product quality consequently demand solid authenticity protection for a plastics product.

Known from the prior art are a large number of security features that can be integrated in or on a plastics product or can be sold together with the plastics product. Effective protection against counterfeiting is called into question merely by the ability to separate a security feature from a product, when only the packaging or another packaging component, such as a certificate, can be provided or authenticated with a security feature. In addition, labels or stickers or feature substances applied by way of a lacquer or by print or in another way or introduced serial numbers, barcodes etc. are relatively simple and banal features. They have the huge disadvantage that they can also be easily copied. However, a significantly greater security level is provided by security features which form an integral part of the product or cannot be separated therefrom without destruction of material. At the same time, it is necessary for reasons of manufacturing economy for no additional production steps to be necessary to introduce the security feature.

In principle, the forgery problem also exists for classical methods, such as injection molded products. A known method for an integrated security feature for plastics parts is based e.g. on the integration of a workpiece insert having a diffraction pattern in a correspondingly prepared workpiece, as is disclosed in WO 2011/131475 by the applicant. This security feature which is economical in the case of large quantities becomes uneconomic for small and very small batch sizes. A visual verification via the hologram-type appearance is here necessary and can be automated only with a high outlay.

### SUMMARY OF THE INVENTION

Proceeding from this prior art, the problem arises of providing a product, which is produced as an individual piece or in small to at most medium-sized series, with an inherent security feature that permits unique and quick authentication, without the production process being burdened with additional steps; in particular without it becoming significantly slower, while offering higher security than the prior art. Small to medium-sized series in this connection means quantities of between 2 to 1000, or 2to at most 100,000 units.

It should furthermore be noted that the existence of a single feature with a feature attribute such as “magnetic” or “yellow luminescent under black light” is relatively easily determinable by counterfeiters and in addition permits no option for personalization. Even if this one feature permits inscription of information, such as the provision of an RFID chip, the inscription of information in the feature, in this example a chip, alone consists of an additional step of the production method. Finally, the chip itself is associated with additional costs, which are not accepted as a matter of course for a competitive product price in all cases where a cost calculation is tight.

This object rather requires with respect to process economy that additional steps are dispensed with in the course of the production due to a personalization of the products. There is therefore a demand for security features, which permit a wide reaching differentiation of individual pieces within the production series. Such a differentiation permits e.g. deductions to be drawn as for serial numbers, batch numbers, batch sizes, date of production etc., depending on the configuration of the personalization. To this extent, personalization in this context does not necessarily mean a one-to-one identification of an object produced in this way, but is also understood to mean identification of the association with a group of produced objects.

Quick authentication also includes the option that the entire process could be performed in automated fashion, including the utilization of the authentication results obtained.

A method in accordance with the preamble of claim 1, which achieves the above-mentioned object, is characterized in particular in that the provision of the at least one second predetermined material comprises: providing at least one second predetermined material for the 3D print, wherein the at least second material comprises the at least one feature substance; and in that the steps of printing or building up and of making available are combined: printing the product or building it up in layer-wise fashion with the predetermined first and second materials at the intended positions in one combined printing step.

In accordance with an embodiment for a three-dimensional printing method for producing a product protected against forgery by way of at least one first security feature, this includes the method steps of providing a digital 3D model of the product to be created, providing the positions for the at least first feature substance for the at least first security feature, providing the digital model as a program code for controlling a 3D printer, providing at least two predetermined materials for the 3D print, wherein at least one material comprises the at least one feature substance, printing the product or building it up in layer-wise fashion with the predetermined materials and the feature substances at the intended positions, and removing the product from the manufacturing facility or working space of the 3D printer and preparing for the intended use.

The provision steps can be performed in different configurations. For example, providing the 3D model can comprise producing the digital 3D model with a CAD method, in particular a CAD method, a 3D scan or by a stored data set; providing the positions of the feature substance can comprise defining the spatial coordinates in the digital 3D model of the object; and providing the digital model can comprise converting the model data into the program code.

The printing process, this term meaning different 3D shape-forming methods explained herein, can preferably be logged and the data sets contained in the log can be uploaded directly into a product database which contains all data specific for each individual product. In simpler implementations, in each case batches with the same specific features are produced and are consequently clones in terms of authentication.

Provided may be a control unit which predetermines the location or the locations of the defined volume element or elements, including their volume dimensions and, in the case of more than one feature substance, the type of the feature substance, for each object produced. These locations can here be determined either from a database or by a random generator from a predetermined set of locations.

In one exemplary embodiment, the predetermined volume element or elements form surface sections of the object to be produced.

In another exemplary embodiment, the predetermined volume element or elements form sections inside the object to be produced, in particular in the case of magnetic feature substances or magnetically detectable feature substances or in the case of transparent or partially transparent or translucent products.

In the volume elements which are provided with feature substances, extensions of e.g. 200×200×200 micrometers are possible, if based on cubes, and meaningful volumes can have an edge length of up to 2×2×2 millimeters. A cuboid having an edge length of e.g. 0.5×0.5×2 millimeter can also be provided, in which case the greatest length is attributed to an orientation along the surface of the product. Here, different responses of the sensors of the detector appliance arise depending on the direction from which the product is observed, wherein this difference also represents a security feature. The length of the strand of the cuboid can be associated e.g. with the batch number or the production period. In the case of methods that operate in layers, such as laser sintering, the volume element can be a complete or a correspondingly applied partial layer.

The feature substance or substances are, for example, up-converters and/or down-converters, in which shortwave radiation is converted to longer-wave radiation (down conversion) and/or longer-wave radiation to short-wave radiation (up conversion) due to fluorescence.

The product database can be located in a decentralized fashion in a mobile or stationary device, in centralized fashion in a server, or it can be located in the cloud and be accessible via different servers.

In a method for authenticating a product protected against forgery with at least one first security feature, the product is arranged on a holding apparatus, a detector device is provided in one or more predetermined positions, the relevant feature properties of the feature substance or substances and its or their positions in the product are registered, the recorded data are compared to the data relating to feature properties and feature positions from a product database, and a report relating to the result of the authentication is created.

The positioning of the detector device is preferably predetermined by data details from the product database. The report can be stored with respect to the authentication result; in particular, the report can be stored in the product database together with the location and the time point of the authentication process and with the identity of the examiner or of the detector device. The report may comprise a comparison of the desired/actual values of the defined property of the feature substance or substances.

In the method, it is possible in the case of predetermined irradiation for the intensity of the sensor response of each defined volume element to be measured and compared to corresponding desired values which are stored in the product database.

Finally, it is possible within the meaning of a yes/no decision for the authentication result to comprise such a binary response.

For additive manufacturing methods, the invention makes provision for a way of achieving the object which includes, in addition to the physical properties, which are relevant for its security function, of a feature substance, which makes up an at least first security feature, a location in respect of a locally defined volume element relative to a spatial reference point as an essential attribute of the security feature.

A preferred embodiment consists in an ensemble of a plurality of security features with the same physical properties at different locations on the surface of the product. In this case, the individual security features form a collective feature which by itself has a higher distinctiveness for the product than an individual feature. Depending on the number of the individual security features—also referred to below as security sub-features—the distinctiveness of the collective feature increases to the extent that individual identification or personalization of the product becomes possible. It is also possible for an ensemble of security sub-features with various feature substances with different properties that are relevant for the physical security function to be realized on the product, for example feature substances that differ in respect of their fluorescence spectrum. The distinctiveness of the collective feature thus increases, but this in turn also involves greater complexity of the forgery protection.

In addition to the spatial coordinates with respect to the spatial vector of the at least one security feature and the relevant properties of the feature substance, e.g. a defined luminescence effect, the object can finally be achieved in a preferred embodiment by way of a requirement for an optimum observation angle for an observer or detector device in order to be able to perform verification to its full extent. The two-dimensional projection of the three-dimensional product, defined by the observation angle, includes the totality of coordinate zero point and an at least first security feature and the possible further security sub-features as a defined network which can be represented quickly and reliably with an imaging detector device or possibly with the human eye. Such a detector device can be e.g. a camera, which takes a recording of the object under specific illumination conditions, which is then in turn subjected to digital pattern analysis.

The coordinate zero point itself also can, but does not have to be, marked with a security sub-feature. For the location of the coordinate zero point, only the self-evident prerequisite that it is fixedly defined applies. It can be a selected point on the product itself or a point on an auxiliary device with respect to a holder, which is possible for the production and/or the examination of the function or the authenticity of the product. A spatial point is understood to mean a mathematical point, which is to be understood to be one located within a spatially narrowly defined volume element. Instead of a detector device which registers all security sub-features that are projected onto the capturing plane with one recording, the security sub-features can also be verified step by step using a detector device that can detect only the feature property, and therefore instead is not installed in a positionally fixed manner, but can travel over a coordinate system (scanning detector), as it were.

It is also possible to set up the two-dimensional projection plane to be not planar, but three-dimensional, for example cylindrical. In this case, the spatial vectors are defined with cylinder coordinates. A scanning detector in this case moves cylindrically around the product, in which case the sensor is always aligned with the cylinder center, that is to say with the product. Other projection planes in three dimensions can be defined by the base area of the “cylinder” not being a circle, but an ellipse, an oval or another closed curve.

Said zero point for the coordinates can also be a sub-security element. In particular if this and/or further easily identifiable sub-security elements are present, said points can then also be referred to as reference points; after all, in that case, a “zero point” is not absolutely necessary. The relative position of said points suffices to calculate the content from the arrangement of the image points from the security sub-features; the evaluation captures the relative location of essential points and calculates a reference plane or a “zero point.” Other pattern detection methods than the ones mentioned here are also possible when establishing the security sub-features.

The production of the product which is protected in accordance with the invention in one embodiment follows the following sequence:

producing a digital model of the product with a suitable digital design tool, or CAD program. The digital model of the product among other things also defines the positions of the security sub-features, of which the collective security feature is composed.

converting the digital model into a program for controlling the additive manufacturing process. This control program includes all instructions and printing parameters for the 3D printer for creating the product (program code). The printing parameters are tuned to the materials used, e.g. construction polymers, supporting polymers and feature substances, colorants etc.

printing the product or building it up in layer-wise fashion with the predetermined materials. The printing process is optionally logged, wherein data sets contained therein can be uploaded directly to a product database which contains specific data for each individual product. These specific data with respect to later authentication of the product in particular include the number and positions of the security sub-features and their relevant properties for the security function. However, it is not absolutely necessary to retrieve data for the product database from the production log. The data, to the extent that they are predetermined, can also be taken in the course of the manufacturing preparation from the digital model of the product or the program code for the production thereof.

unpacking the product, i.e. removing the product from the manufacturing facility or the working space of the 3D printer and removing production residues, supporting constructions and supporting polymers.

The authentication of the product is performed in accordance with an embodiment substantially by way of the following steps:

securing the product on a holding apparatus,

positioning the detector device as per specifications from the product database,

registering the relevant feature properties and positions of all sub-features,

comparing the recorded data to the data relating to feature properties and feature positions from the product database, and finally

creating a report relating to the result of the authentication.

In the simplest case, the result of the authentication is a simple yes/no response in the meaning of real/counterfeit. However, the report can also be a complete log relating to the authentication process with all measured and stored data. A comprehensive report can of course also be adapted to the circle of recipients of the report. Optionally, the authentication is here supplemented by a further step:

saving the authentication result itself, preferably together with the location and the time point of the authentication process and with the identity of the examiner or of the examination device, in a product database, which can then be used for a statistic evaluation of increasing counterfeiting occurrences, movements of goods etc.

Generative manufacturing methods or additive manufacturing—also AM—is a comprehensive term for methods which have hitherto been referred to as rapid prototyping, for the fast and cost-effective manufacturing of models, patterns, prototypes, tools and end products. This manufacturing is performed directly on the basis of the computer-internal data models (transfer typically via the STL interface) from formless (liquids, powders and the like) or form neutral (tape, wire) material using chemical and/or physical processes. Although this is a primary shaping method, no specific tools that have stored the respective geometry of the workpiece or of the product (for example injection molds) are required for a specific product.

In accordance with DIN 8580, primary shaping refers to all manufacturing methods in which a solid body is produced from a formless substance. The form of a geometrically determined, solid body is produced here and the material cohesion is brought about. The starting substances used can be liquid, granular, or pulverulent, or alternatively be made available as plastic semifinished products.

3D printing is differentiated in terms of process technology as powder bed methods (selective laser melting (SLM), selective laser sintering (SLS), selective head sintering (SHS), binder jetting (solidification of powder material using a binder) and electron beam melting (EBM)), free space methods (including fused deposition modeling (FDM) or fused filament fabrication (FFF), laminated object modeling (LOM), contour crafting, gastronomic cold spray and electron beam welding) and liquid material methods such as stereolithography (SLA), digital light processing (DLP) or liquid composite molding (LCM). Particularly preferred for the invention are methods that successively merge thermoplastic material from defined elements to form a product. Such elements can have any desired shape, for example drops, be strand-shaped or consist of layers. A 3D printing method which is preferred for producing plastics products in small quantities is fused deposition modeling (FDM) or fused filament fabrication (FFF), in which preferably a thermoplastic material is applied in the form of a strand from a nozzle to form the desired structure.

Suitable thermoplastics are for example, i.e. the list is not exhaustive, polymers such as ABS, PC, PLA, HDPE and PPSU. In addition, a large number of composite materials are available, e.g. Laybrick or Laywood, which exhibit a ceramics-like or wood-like behavior. It is also very easily possible to use as part of the invention the 3D printing using photopolymerizable, in particular UV curable, plastics. Layer-wise applications are known by the term laminated object modeling (LOM). Marking an object can consequently also be performed by a method according to which the printable starting material cannot be applied as a semifinished product (such as a filament) but, as is generally well known, in the form of a powder via drop formation. In this respect, see EP 2 860 020 A1.

Within the meaning of the invention, in particular methods are understood to be 3D printing methods if they build up and produce a three-dimensional object in elementary fashion on the basis of a digital model. A commercially available model, which is operated not with filaments but with liquid resins, is the M-One DLP 3D Printer by Makex Technology. Also widely used are filament-based 3D printers, for example by Witbox, Gimax, Mankati, Craftbot, ZYYX, Ultimaker, 3dfactories, Robox, Lion3D, Makerbot, GermanRepRap, iRapid, etc. Excellent industry devices are also offered by Voxeljet, Align Technology or Stratasys. Of particular importance are industry-suitable methods in connection with the cross-industry project “Industry 4.0,” which also became known as the “Internet of Things.”

According to the inventive solution, security features applied by 3D printing are integrated in the object to be produced such that the three-dimensional shape of the object does not differ from its unmarked variant. Consequently, the shape of the object, which can be decisive in terms of the function of the object, as is frequently desired by the producer, remains unaffected by the mark.

With respect to the implementation of a security feature in an object produced by additive methods, the prior art discloses solutions that are based on one or more cavities within the produced printed piece, such as in WO 2011/036087 A1 (Pilz et. al.) and EP 2 837 444 A1. For the recognition of original parts, WO 2011/036087 A1 suggests that the latter, preferably produced with a selective sintering or melting method, in the case of a porous interior of an object, recording the individual structure with X-ray or ultrasound technology and store it, as it were, as a fingerprint or to provide cavities, created in a controlled fashion, which are filled with the same material of different density, which would be possible by incomplete sintering or melting. WO 2011/036087 A1 fails to describe the implementation of an authentication of the product in more detail, and simply provides a reference to X-ray or ultrasound analysis, for example computed tomography. The method by Pilz et al. is consequently aimed at products which were produced with powder bed methods such as SLS or SLM and are produced as individual pieces or in small quantities and rather as expensive investment goods with extremely high security requirements. Turbine blades are a known example for this product category. The development of the method, in which artificially created cavities are filled with magnetic material, does not reduce the complexity of the method. Checking a distribution of cavities is in any case an authentication on a forensic level and not very suitable for a quick and cost-effective authentication of small or even medium-sized quantities. In some options in accordance with the previously known solution it is necessary to integrate an additional step in the production process (closing empty cavities or filling the same with magnetic material), which is exactly what is to be avoided within the meaning of the solution proposed here.

EP 2 837 444 A1 takes a similar direction, wherein the inventors in this case focus on producing a type of indentation in the surface, introducing an identifier therein in a second step, and then closing the filled indentation in a further step, by placing a thin layer of the construction material over the opening of the indentation. This proposal likewise requires additional steps during production. Moreover, EP 2 837 444 A1 does not present any concrete workflow which already begins at the stage of the digital model and ends in a verification, and especially does not include the following steps with respect to data utilization. In this solution approach, reference is made as personalization to an ID chip, which for reasons of costs and the additional outlay for the installation thereof in the product is not a practical way of achieving this object.

In neither proposal of the prior art mentioned above, i.e. WO 2011/036087 A1 or EP 2 837 444 A1, were the location of the security feature or the positions of the sub-features on or in the object broached. Instead, in accordance with embodiments of the present invention, the location of a security feature on or in an object is included in the security concept as a feature property, which opens a possibility for individualization (personalization) of the object and overall offers a higher security level.

The core of the present inventive solution is, inter alia, producing an object in accordance with the abovementioned criteria, in which a subsequent examination comprises finding the location thus produced of a feature substance and a property check thereof, as a result of which a security feature is defined which permits authentication of a product or original product.

In a preferred use, the three-dimensional printing method with the steps for authenticating a product which is protected against forgery by way of at least one first security feature from the printing method is used:

A three-dimensional printing method for the production of a product which is protected against forgery with at least one first security feature with authentication of the at least one first security feature consists of the following method steps: providing a digital 3D model of the product to be created, providing the positions for the at least first feature substance for the at least first security feature, providing the digital model as a program code for controlling a 3D printer, providing at least two predetermined materials for the 3D print, wherein at least one material comprises the at least one feature substance, printing the product or building it up in layer-wise fashion with the predetermined materials and the feature substances at the intended positions, storing the relevant feature properties of the feature substance or substances and its position or their positions in the product in a product database, removing the product from the manufacturing facility or working space of the 3D printer and preparing for the intended use, positioning a detector device in one or more predetermined positions relative to the product, registering the relevant feature properties of the feature substance or substances and its or their positions in the product, comparing the recorded data to the data relating to feature properties and feature positions from a product database, and creating a report relating to the result of the authentication.

The relevant feature properties of the feature substance or substances and its or their positions in the product are stored in a product database. Product database here means, for example, an external database of all or at least a subset of the produced products, wherein the printing process is logged and the data sets which are contained in the log and contain all data specific to each individual product are directly uploaded into this product database. It can also be an in particular encrypted data set which is printed on the product itself. This can be a steganographically provided print, for example, in the region of a manufacturer's logo or a type designation, wherein steganography is chosen to provide said details in a manner which does not disturb the user.

Providing the positions of the feature substance comprises in a first step the definition of the spatial coordinates in the digital 3D model of the object. This means in terms of content that the positions are predetermined. This predetermination can be effected deliberately by deciding the operator of the 3D printer/producer of the product, or it can be a random selection within the context of possible sensible positions.

Further embodiments are set forth in the dependent claims.

A further aspect of the invention is the provision of the feature substance for the additive digital fabricator, or fabber in short. The product is produced by successive addition or deposition of material. This is not stereolithography, where a focused UV light beam solidifies the surface in layer-wise fashion in a pool of synthetic resin, but a method in which a binder is used to additively spray quickly curing material, depending on application plastics, plaster, powder for metals or glass, silver, cobalt chromium, mineral dust, sand etc., layer by layer. The invention therefore also relates to a set of at least two 3D printing materials, at least one of which is admixed with a substance which is usable as a security feature, in particular from the group of the optically luminescent substances, the colorants which are visible under IR or UV irradiation, and magnetic substances.

### BRIEF DESCRIPTION OF THE DRAWINGS

Preferred embodiments of the invention will be described below on the basis of the drawings, which serve merely for explanation and are not to be interpreted as being restrictive. In the drawings:

FIG. 1a shows a schematic perspective illustration of a product or of an object to be protected,

FIG. 1b shows an illustration similar to FIG. 1a of a product with an additional cavity, which involves additional manufacturing outlay,

FIG. 1c shows an illustration similar to FIG. 1a of a product which is provided with a security feature in accordance with an embodiment of the invention,

FIG. 2 shows an illustration of the product in accordance with FIG. 1c arranged on a holder and together with a detector device,

FIG. 3a shows an illustration of a product with three security features similar to FIG. 2,

FIG. 3b shows a schematic front view of the product in accordance with FIG. 3a from the perspective of the detector device,

FIG. 3c shows a schematic illustration of the image of the product in accordance with FIG. 3a, which is detected by the detector device,

FIGS. 4a-4c show an illustration of a product with two security features similar to FIG. 2 and a scanning detector device,

FIGS. 5a-5c show an illustration of a product with two security features similar to FIG. 2 and another scanning detector device,

FIG. 5d shows an illustration of a product with two security features similar to FIG. 2 and a scanning detector device in accordance with FIG. 5a in a different configuration,

FIG. 5e shows an illustration of a product with two security features similar to FIG. 2 and a scanning detector device in accordance with FIG. 5a in another different configuration,

FIG. 6a shows a flowchart of the production of the product with the production of the associated first feature information as a method sequence,

FIG. 6b shows a flowchart of the authentication of a product,

FIG. 7a shows a schematic view of a partially finished product with the application of a filament, and

FIG. 7b shows a schematic view of a partially finished product in an early build stage, in which no feature substances have been introduced into the product yet.

### DESCRIPTION OF PREFERRED EMBODIMENTS

The invention will be described in connection with the drawings on the basis of preferred embodiments of the method, of the apparatuses for performing the method and of the correspondingly produced products or objects, which represent the subject matters to be protected.

The digital model of the object, as is presented for a first exemplary embodiment, is produced with suitable software such as Autodesk 123D design or Blender and converted with a further suitable program, e.g. Slic3r, to 3D printing data. It should be noted that the software used supports 3D printers with a plurality of extrusion nozzles or their simultaneous operation. The 3D printer used and presented in the described exemplary embodiment in connection with schematic is in this case a device (at least) in dual-extruder implementation, wherein the object is substantially produced from a first polymer. In this example, the polymer is ABS (acrylonitrile butadiene styrene polymer), which is fed to the printer in the form of a filament with a thickness of 1.75 mm.

The printer additionally has a heated print bed which is necessary for producing products made of ABS. The temperature of the print bed is 100° C., but can be correspondingly adapted for an optimum print result. If necessary, the heating of the print bed is capable of being switched off, but in the case of ABS as the construction polymer, this is not recommended. The temperature of the first extrusion nozzle is regulated for example to 230° C., wherein for optimizing the print result, a margin of ±20° C. is available. The second extrusion nozzle is available for the targeted application of the security feature. The security feature is likewise provided as a filament of 1.75 mm thickness, wherein, in contrast to the construction polymer, it additionally contains a feature substance.

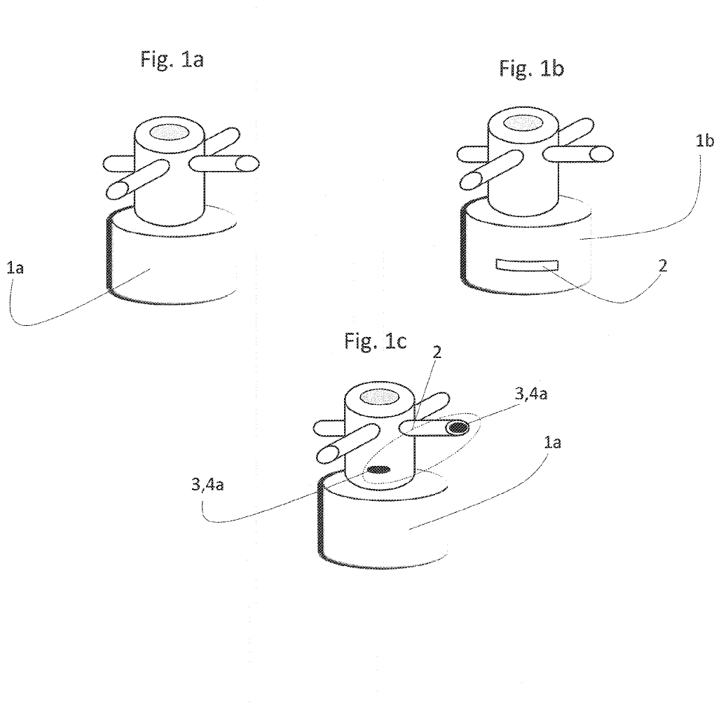

FIG. 1a shows a schematic perspective illustration of a product or of an object 1a to be protected. FIG. 1b shows an illustration similar to FIG. 1a with the product 1b with an additional cavity 2, which involves additional manufacturing outlay. There are cavities 2, which are not stable during manufacture or where there is a risk that the semifinished structure will deform. Larger cavities cannot be covered by the construction polymer without being temporarily filled. The cavity 2 from the figure is intended as an example of a somewhat more complicated case, in which the use of a supporting polymer cannot be dispensed with.

FIG. 1c shows a schematic illustration, similar to FIG. 1a, of a product 1a in accordance with an embodiment of the invention, which is provided with a security feature 2, which is comprised of the drawn curve and consists of an at least first feature substance 3 at two different positions 4a and 4b.

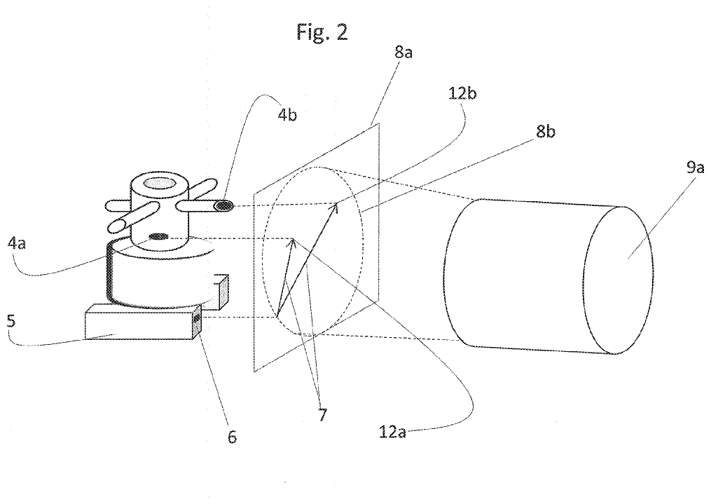

FIG. 2 shows a product 1a in accordance with FIG. 1c on a holder 5, which is arranged together with a detector device 9a. The product or object 1a having the security feature 2 is arranged to be at rest on a holder 5, in particular secured thereto. Here, a specific spatial element is defined as the coordinate zero point 6 by way of the holder 5. It is also possible for the coordinate zero point 6 to be defined at a predefined location of the product 1a. The coordinate zero point 6 is the starting point for spatial vectors 7, which describe the positions of the feature substances. The projection of the spatial vectors to the positions of the at least one first security feature in a plane forms a first piece of feature information. The capturing plane 8a between the product 1a and a detector device 9a for the security feature 2 forms a first piece of feature information 10, which can be stored in an object database 11, in addition to further information relating to the product 1a, or can be compared, in real time or with a time offset, to other feature information located in said object database.

The feature information can be patterns, which result from the location of the spatial vectors, or can be other representations, such as hash values which are calculated from the patterns. The representation is of the distribution patterns can optionally be encrypted and thereby stored in an object database in the form of encrypted data sets. The detector device 9a has a capturing surface that can at least partially capture all possible projection locations 12a, 12b on the capturing plane. Accordingly, a sensor with a suitable surface extent is situated in the detector device. The detector device can be a conventional image sensor having a sufficient sensitivity for the emission color of the feature substance. A 16-megapixel sensor with an upstream Bayer sensor makes available for example 4 million color-sensitive sensor points. Even if this number is reduced by way of an upstream anti-aliasing filter, it is easily possible to achieve a resolution of 1000×1000 color image points. If the projection surface that is covered by the sensor in an exemplary embodiment is 10 cm×10 cm, a spatial resolution of 0.1 mm×0.1 mm in any desired color is possible.

It is also possible to operate with resolutions of up to 1 mm×1 mm. In the case of feature substances in which the security element is made available by way of an optical response, such as luminescence, the stated resolutions provide a goal and are easily attainable. In magnetically reacting features substances, good resolutions are attainable only by direct, and not almost direct, placement of sensors on the surface of the object/product. This results here in a more complicated check or a significantly more limited resolution. When using magnetic security elements, installation underneath the surface of the object is possible. It is also possible to make the volume elements which build up the security element greater inside the object than at the surface, with the result that a counterfeiter is not able to produce a cavity and to then fill the cavity easily with the feature substance. The method of printing the product or building it up in layer-wise fashion with the predetermined first and second materials at the intended positions in a combined printing step here displays its advantage, because greater volume elements can be provided in the interior of the object to be protected.

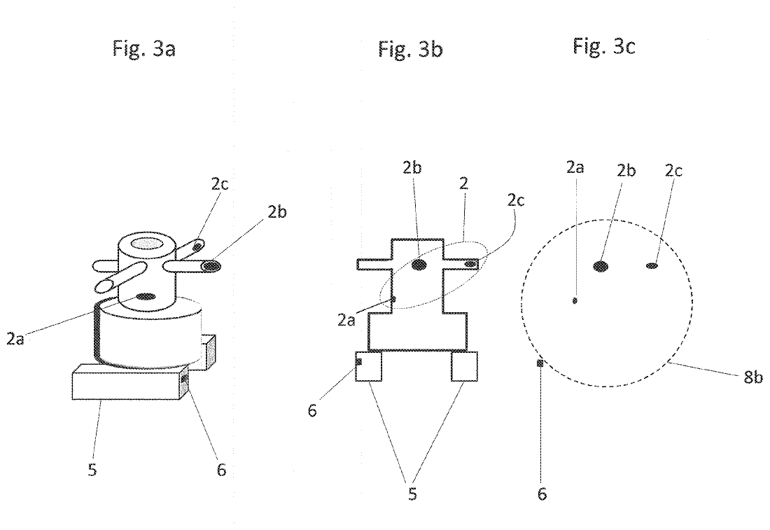

FIG. 3a shows an illustration of a product with three security features similar to FIG. 2. FIG. 3b in this respect shows the schematic front view of the product in accordance with FIG. 3a from the perspective of the detector device 9a. FIG. 3c shows the schematic illustration of the image of the product in accordance with FIG. 3a, which is detected by the detector device 9a.

Accordingly, FIG. 3a shows an exemplary embodiment of a product or an object 1a with three security features 2a, 2b, 2c resting on a holder 5, on which a specific spatial element is defined as the coordinate zero point 6. In the present case, there are three security sub-features which are defined by an identical or different feature property 3 and their positions on the product 4a, 4b and 4c on the surface of the object or product. If, in accordance with FIG. 3b, the front view of the object is shown from a possible perspective of the detector device, the detector device 9a in accordance with FIG. 3c will observe on the capturing plane 8a the security feature or the security sub-features 2a, 2b and 2c, possibly also the zero point 6 within a capturing surface 8b. The capturing surface can here be defined by a circular optical unit with a connected sensor, e.g. a camera sensor, which is able to assign spatial coordinates to the detected sub-features, as is the case e.g. in a CCD sensor or CMOS sensor. However, the capturing surface 8b also have a different shape, such as rectangular or square. The result of the detection is a distribution pattern of the feature substances on the surface of the object, which results from the spatial coordinates. The distribution pattern and the relevant property of the security feature, e.g. a luminescence at 580 nm (nanometer), are specific to the personalizable security feature. The distribution pattern or a representation thereof, even an encrypted one, are stored in the form of a data set in an object database for comparison purposes or are stored therein by the authentication process.

It should be noted that the security features are presented as points of different size and additionally have different shapes. Both properties can be detected and used as further aspects of the security features. In addition, the security features 2a, 2b and 2c, which are printed here in black as “single-color” points, can be detected here as luminescence at different wavelengths.

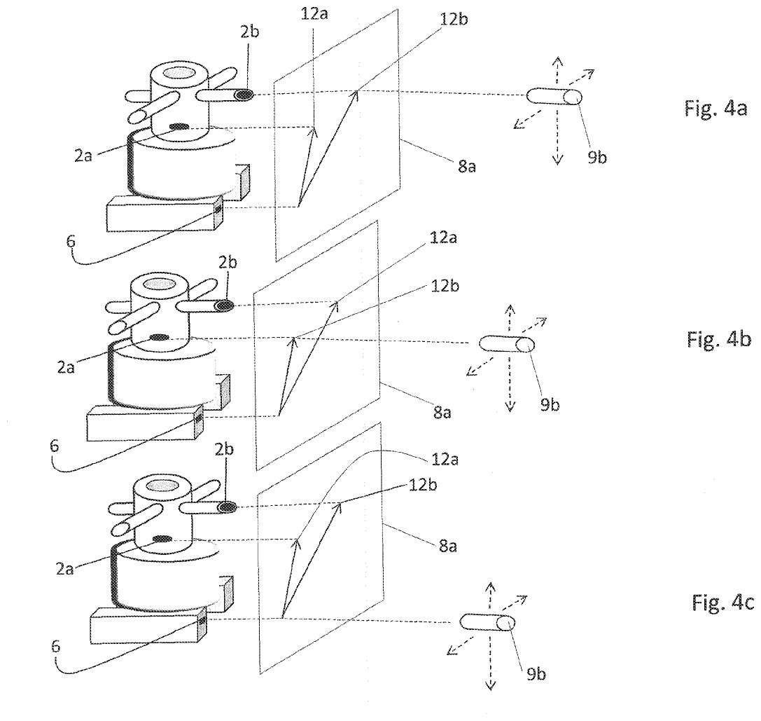

FIGS. 4a, 4b and 4c show an illustration of a product with two security features 2a and 2b similar to FIG. 2 and a scanning detector device 9b. The product or object 1a with the security features 2a and 2b is arranged at rest on a holder 5, on which a specific spatial element is defined as the coordinate zero point 6. The coordinate zero point is the starting point for spatial vectors 7, which describe the positions of the feature substances. The projection of the spatial vectors to the positions of the at least first security features on a plane as the capturing plane 8a between the product 1a and a detector device 9b for the security feature 2 forms a first piece of feature information 10, which can be stored in an object database 11, in addition to further information relating to the product 1a, or can be compared to other feature information located in said object database.

In this embodiment, the detector device 9b cannot simultaneously capture the individual projection locations 12a, 12b, but must target the projection locations individually, to which end it either moves to predetermined positions or scans the entire capturing plane in a search mode. The coordinate zero point is not necessarily to be understood as a physically marked point on the product or a holder, but can also be a defined location in the holder or scanning apparatus of the detector device 9b. It is likewise feasible to store the coordinate zero point 6 and the spatial location (position, location and orientation) of the detector device as a parameter in the software of the detector device.

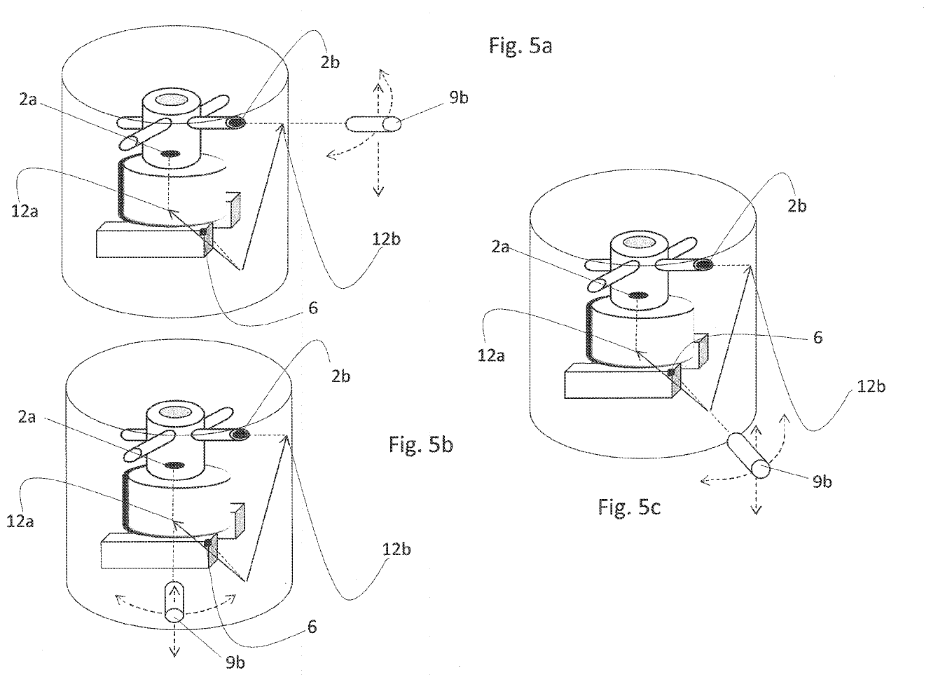

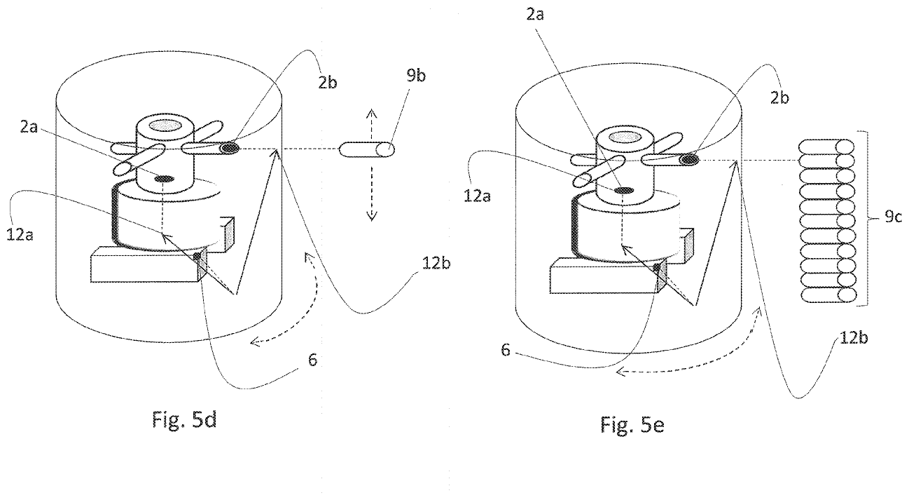

In the embodiment in accordance with FIGS. 5a to 5c, the capturing plane of the detector device has a cylindrical shape, wherein the detector device 9b moves circularly in an alignment with the central axis (z-axis) and in a 90° orientation with respect to the z-axis of the product. The detector device can in this embodiment move around the product for the purposes of verifying the sub-features 2a, 2b such that it moves to the predetermined position locations 12a, 12b and possibly also the coordinate zero point 6 one after the other, or such that the cylindrical capturing plane is systematically scanned. The scanning variant is applied if the coordinates of the sub-features 2a, 2b are not previously known.

FIG. 5d shows an illustration of a product with two security features similar to FIG. 2 and a scanning detector device in accordance with FIG. 5a in a different configuration. FIG. 5d here shows the process of authentication, wherein a rotating product moves in steps past a detector device such that it rotates in an xy-plane and the detector device 9b performs a scan in the z-direction with each step. In other words, the product rotates about its axis, while the detector device is displaced linearly in the z-direction. The movements (rotation and linear movement) can be simultaneous or be performed in alternation.

FIG. 5e shows a further embodiment, in which the detector device 9c captures in one go a narrow detector-wide surface aligned in the z-direction and the product moves in steps in the xy-plane during an authentication, while the detector device 9c captures with each step a section of the projection surface that is aligned in the z-direction in one go, in column-wise fashion, as it were. This variant, as a practical embodiment, is a faster variant of the implementation in accordance with FIG. 5d. The reference sign 9c represents the array of sensors which are arranged in lines, which array represents the detector device operating in column-wise or line-wise fashion. FIG. 5e shows the illustration of a product with two security features similar to FIG. 2 and a scanning detector device in accordance with FIG. 5a in another different configuration.

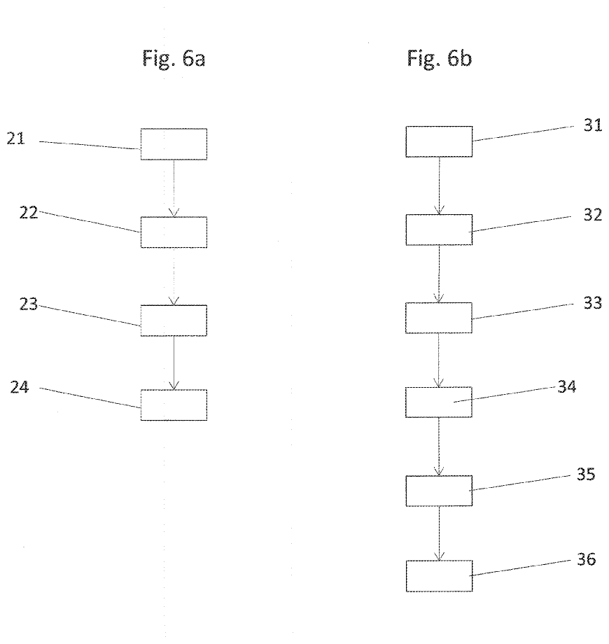

FIG. 6a shows the production of the product with the production of the associated first feature information as a method sequence. The production method is broken down here into the following steps:
Step 21: producing a digital model of the product with a suitable digital design tool or CAD program, including the positions of the sub-features of which the collective security feature is composed.
Step 22: converting the digital model into a program for controlling the additive manufacturing process.
Step 23: printing the product or building it up in layer-wise fashion with the predetermined materials. The printing process is optionally logged, wherein data sets contained in the log can be uploaded directly to a product database which contains specific data for each individual product. Printing here comprises as a generic term 3D production methods, in particular the ones mentioned here.
Step 24: unpacking the product, i.e. removing the product from the manufacturing facility or the working space of the 3D printer and preparing for the intended use, for example removing production residues, supporting constructions and supporting polymers.

FIG. 6b visualizes the authentication of the product, the sequence of which is substantially characterized by the steps of:
Step 31: securing the product on a holding apparatus.
Step 32: positioning the detector device in accordance with predetermined specifications, in particular in accordance with specifications from the product database. It is also possible to move to different positions one after the other, to test, so to speak, which specific combination of security features at the pattern could be realized.
Step 33: registering the relevant feature properties and positions of all sub-features.
Step 34: comparing the recorded data to the data relating to feature properties and feature positions from the product database.
Step 35: creating a report relating to the result of the authentication.
Step 36: (optionally) saving the authentication result itself, preferably together with the location and the time point of the authentication operation and with the identity of the examiner or the examination device, in the product database.

Steps 32 to 34 can also be iteratively performed more than once, if in the pattern examined different specific combinations of security features could be realized, with the result that moving to different positions one after the other is necessary, of which only one then has all the security features.

It is also possible that, as part of a rougher scan, first security features which are more easily ascertainable are examined and then, in a second scanning step, further security features, which require a different sensor setting and/or increased resolution.

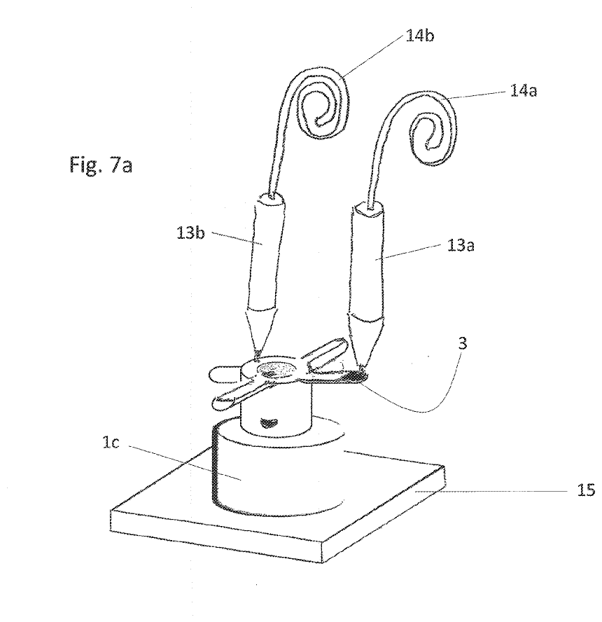

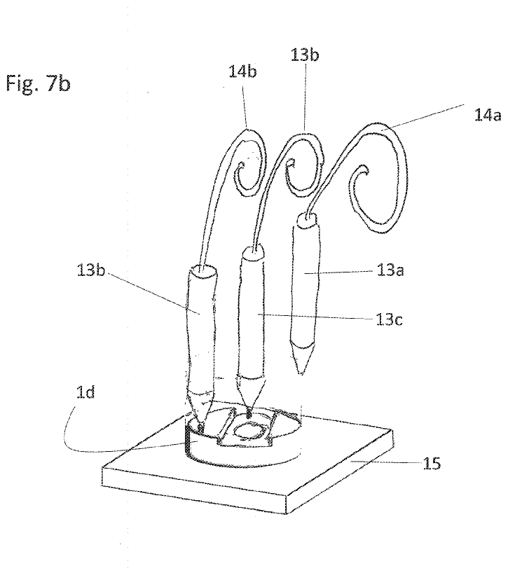

FIG. 7a shows a schematic view of a partially finished product lc at a stage in which a feature substance 3 is applied using an extrusion nozzle 13a, wherein a filament 14a consisting of a polymer containing the at least first feature substance 3 is extruded into a defined position. In the meantime, an extrusion nozzle 13b extrudes a construction polymer, of which the actual product consists. The construction polymer is applied via a filament consisting of the construction polymer 14b. The product in finishing lc rests on a thermostatic print bed 15.

FIG. 7b shows a partially finished product ld in an early build stage, in which no feature substances have been introduced into the product yet. The extrusion nozzle 13a with the filament 14a, which contains the feature substance, is not in operation, or in waiting mode, as it were. By contrast, next to the extrusion nozzle that applies the construction polymer 13b, a further extrusion nozzle 13c is operating, which at the same time as the nozzle 13b that applies the construction polymer applies a supporting polymer, which is supplied by the corresponding filament 14c. The supporting polymer serves for stabilizing the product during its production, for example to fill cavities. Once the manufacturing process is complete, it is removed, because the finished product no longer requires stabilization by the supporting polymer.

A filament of this type with a feature substance can be what is known as an up-converter, which exhibits green luminescence after stimulation with an IR laser. To increase the quantum yield, a transparent polymer is selected as a matrix for the feature substance, although not necessarily. Due to the small spatial extent of the security feature, this transparency in the otherwise colored surrounding of the security feature is not noticeable.

Other feature substances can likewise be used, such as down-converters (which exhibit luminescence at higher wavelengths), IR pigments, pigments with metameric colors, or phototropic substances. In very general terms, practical for a security function are all features substances that interact with electromagnetic radiation or with electromagnetic fields by being excited by said radiation or said fields or reflecting them in a characteristic fashion, such that a response reaction which is typical for the feature substance can be ascertained with suitable measuring devices (detector devices). Such a response reaction can be a luminescence, a changed color effect, a magnetization etc. The electromagnetic radiation can act specifically for the feature substance by various parameters, for example frequency, field strength, polarization, possibly pulse properties etc. Finally, feature substances that can be verified in an acoustic method, in particular by ultrasound, are also suitable. However, a basic prerequisite is that the relevant property of a feature substance which may be suitable can be ascertained using the detector device practically without contact and without damaging the original product.

Other filament diameters, such as e.g. 2.85 nm, are also possible.

In the method in accordance with the invention, one or more of said volume element which comprises the security element are integrated in the product in a defined position. Knowing the position of the mark and the verification method of the properties of the feature substance is necessary for later authentication.

The verification method consists, for example, of the properties of the security feature, the resulting examination criteria, and a computation unit in a control unit for calculating the result.

Directly after finishing the printing operation, the object that is marked with the feature substance is unpacked, wherein unpacking comprises removing the object from the printing device, including removing production residues such as powder, supporting polymers etc., and is subsequently available for its intended use or for authentication. The verification of the up-converter is performed with an IR laser, which can be available in an exemplary embodiment as a hand-held laser pointer. A luminescence at the predetermined location represents the positive verification result. The result can, but does not have to, be stored or documented.

In accordance with another exemplary embodiment, the digital model of the object is produced with suitable software such as Autodesk 123D design or Blender and converted with a further suitable program, e.g. Slic3r, to 3D printing data. It should be noted that the software used supports 3D printers, here with at least three extrusion nozzles or their simultaneous operation. The 3D printer used is in this case a device in triple-extruder implementation, wherein the object is substantially produced from a first polymer. In this example, the polymer is also ABS (acrylonitrile butadiene styrene polymer), which is fed to the printer in the form of a filament with a thickness of 1.75 mm. The product or the printed piece, however, contains very filigree structures as compared to the first example. In order to obtain a good printing result, the second printing head extrudes a supporting material, suitable material being e.g. PVA (polyvinyl alcohol) at a printing temperature of 190° C. After unpacking the freshly printed product, it is flushed with water until all residues of the PVA material have been removed from the printed piece. The third printing head finally serves for the application of the thermoplastic containing the feature substance. The feature substance in this example can be identical with that from the first exemplary embodiment. In this case, the authentication is performed identical to the first exemplary embodiment.

In a further exemplary embodiment, an object which has been manufactured in accordance with the previous exemplary embodiment has a highly complex topology, which is additionally implemented in the material shaping with small tolerances at the original manufacturer's site to ensure the problem-free function of the object. If it is moreover known that counterfeit products are in circulation which have a deceptively similar shape, but under more accurate examination exhibit a different mass and tolerances and consequently, as a functional element, tend to cause disturbances in continuous operation, then in such a case the shape of the object can be incorporated in the authentication process. Stored in a database containing the basic data for the authentication of the product is, in addition to the position of the security feature on the product, the examination criteria and the algorithm for calculating the results of the authentication, a digital model. The verification of authenticity in this exemplary embodiment consists in scanning the shape of the object using a 3D scanner and subsequently creating a digital data set, to which the digital model of the original product is compared. The location of the security feature is here a defined coordinate in the digital model of the object. The examination apparatus for the security feature takes the stored position as a basis to perform the verification at said location. This operation can be performed both manually and in automated fashion.

In another exemplary embodiment, the object is built up using a layer-wise method, for example selective laser sintering. The defined volume element in this case is a layer containing the feature substance. The construction material can be supplied using a roller or doctor blade, while a second layer serving as the security feature is applied using a doctor blade. This method is recommended for purely metallic objects. It is e.g. feasible to introduce into a metallic substrate suitable rare-earth metals as the feature substance, which is applied using the second doctor blade. During the verification of the authenticity of the object, it would be possible to see a visibly luminescent line in a region that is irradiated with an NIR laser.

In a further exemplary embodiment, the object is printed using a method that is based on the solidification of a powder material using a binder (binder jetting). Similar as in the case of laser sintering (SLS) or other powder bed methods, the three-dimensional object is built up by powder material solidifying at selected spatial coordinates. Commercially available devices for binder jetting combine the binder with colored inks so as to reconstruct colored objects in this way. For this type of 3D printing, the term 3D inkjet is also common. Devices operating according to this principle are e.g. available by 3DPandoras or 3DSystems. A defined volume element, which is provided as the location for the security feature or a sub-feature, is built up in this application by an ink containing a feature substance and the binder. The ink can—but does not have to—contain, in addition to the feature substance and the binder, colorants or color pigments. It is e.g. feasible in a simple case to design the feature substance as black with a high absorption in IR and to give the security feature the shape of a matrix barcode. In a coloration which is otherwise black with low IR absorption as the matrix barcode, the matrix barcode would not be visible, or only with great difficulty, with the naked eye, but can be seen easily under IR light.

The location of the security feature on the surface of the product can be ascertained as follows:

A) using a positionally fixed, permanently defined position of the examination device and first a stop, which serves to secure the product in the location that is correct for the examination This is, as it were, a three-dimensional template to a This type of verification is quite simple and suitable for verifying series products. Insertion and measuring can be done both manually and in automated fashion, for example using a robot which places the products in such a template and takes them out again after the verification or examination operation. This sequence can be performed very easily in program-controlled fashion. It is possible to achieve a higher automation degree and a greater flexibility of the verification device if such a camera-controlled robot removes various products from a conveyor belt or collection container via pattern recognition and possibly places them into different examination devices.

B) using an examination device which, in accordance with the recognition of the product due to a serial number or another individual property of the product, can move itself to a specific position to perform the verification. Such a method is suitable in particular for verifying individual pieces that can carry marks individually at different locations. The examination device does not necessarily have to move to the verification location on the surface of the marked product in automated fashion. An examiner can perform this manually, as long as he has clear documents, e.g. In the form of a three-dimensional (perspective) drawing, which uniquely identify the marked location.

C) using a tomographic method, which captures the product as a 3D X-ray image, as it were, and recognizes the feature in question in one step. Such a method can operate both with a tomography device with movable parts, such as a goniometer and with a tomography device without movable parts, such as an X-ray device (computed tomography). Such a method would also be feasible in a form in accordance with FIG. 5e, wherein the array-type detector device 9c would be supplemented by a further sensor capturing the shape of the product, e.g. an ultrasound sensor. Industrial CT methods are typical in the product creation process and are also recommended for 3D printing. (Julia Kroll et al, Industrielle Computertomographie im Produktentstehungsprozess—Am Beispiel des Kunststoff-Lasersinterns, ndt.net). A tomographic method also permits the detection of security features that are located within the product or under the surface, for example a volume element of a polymer material having a different density as compared to the surrounding material. A tomographic method can be used particularly well for examining individual pieces.

Necessary component of all verification methods is the knowledge relating to the location of the security feature, which is ascertained in some form as a characteristic for the individual or serial product in the form of a coordinate. The typical coordinate for the product can be stored in the examination device itself, which can be a mobile, semi-stationary or stationary device, in a decentralized or central database, or in the cloud. A coordinate in the meaning in accordance with the invention can also be noted on a product data sheet. A database consequently does not exclusively mean an electronic or digital database, but the term can also refer to a paper notation.

Furthermore, all verification methods have in common that the 3D printer is able to apply the security feature at a selected location of the product to be produced. Suitable for this are, for example, all devices in accordance with the FDM method with an at least second extrusion head (e.g. commercial devices by Airwolf 3D (Airwolf HD2x), Mankati (Fullscale XT Plus), 3D Systems (CubePro Duo and CubePro Trio) or Builder 3D (Builder Dual)), or devices having a multi-extrusion head e.g. in accordance with Stratysys Polyjet technology.

Furthermore, the result of the verification of the authenticity of the product—at least as a yes/no statement—is output and optionally stored in the database. An expanded result of a verification of the security feature in the defined volume element using a method includes properties of the feature substance for its use as a security feature. An example is the spectral parameters of the feature substance, such as the luminescence at a specific wavelength.

If the verification result is stored in a database, the number of the verifications with their respective results can also be stored as a further security advantage. Further additional data such as the Geo data or the identity of the examiner are feasible and refine the optionally possible statistic evaluation of the verification results.

The security feature applied by 3D printing is integrated in the object such that the three-dimensional shape of the object does not differ from its unmarked variant. Consequently, the shape of the object, which can be decisive in terms of the function of the object, remains unaffected by the mark. Consequently, the security feature cannot be captured by touch and is thus for example not suitable as a basis for Braille. However, it is feasible to integrate a feature in a product which is capable of being captured by touch in a highly subtle fashion. This is a special case, in which the output of the verification result is merely the determination that the expected tactile impression is formed at a specific location.

The method in accordance with the invention comprises in one embodiment substantially the method steps:

creating a digital model of the object by a CAD method or 3D scan,

establishing a defined volume element by the spatial coordinates in the digital model of the objects,

3D printing the object using a 3D printer with at least two printing heads in accordance with a specification of the digital model, wherein the at least one second printing head is reserved for the application of a printing material having a feature substance with a defined property to produce a security feature in the defined volume element. The printing heads can also be integrated in a multi-printing head.

verifying the security feature in the defined volume element using a method, which recognizes the properties of the feature substance for its use as a security feature.

comparing the desired/actual values of the defined property of the feature substance, and finally, optionally:

declaring the result as such, e.g. on a display, by way of a printout or by storing it (with the conjunction in this case not being an exclusive “or”).

### LIST OF REFERENCE SIGNS

1a complete or finished product
1b complete or finished product with an additional cavity
1c partially finished product in a product stage in which a feature substance is being introduced
1d partially finished product in a product stage in which a cavity is being filled with a supporting polymer
2 security feature
2a-c security sub-features
3 first feature substance
4a-c positions in the product at which feature substance is introduced
5 holder for the product
6 coordinate zero point
7 spatial vectors
8a capturing plane onto which the positions of the feature substances are projected
8b capturing surface of the detector device
9a detector device having a capturing surface which covers the entire product, which is projected onto the capturing plane, or essential parts thereof and thereby captures the entire security feature with one recording
9b detector device that captures only one position at a time in each case
9c detector device having a capturing surface which covers a narrow region along the z-axis of the product
10 feature information
11 object database
12a-c projection locations
13a extrusion nozzle for the feature substance
13b extrusion nozzle for the construction polymer
13c extrusion nozzle for the supporting polymer
14a filament with feature substance
14b filament composed of construction polymer
14c filament composed of supporting polymer
15 print bed (heated with temperature regulation)
21 producing the digital model of the product
22 converting the digital model into a program code for controlling the 3D printer or the apparatus for the additive manufacturing method
23 printing the product or building it up in layer-wise fashion
24 removing the product from the manufacturing facility and removing production residues, supporting constructions and supporting polymers
31 securing the product on a holding apparatus in a specified manner
32 positioning the detector device
33 registering the feature properties by way of the detector device. This step is possibly performed several times.
34 comparing the data recorded by the detector device for characterizing the security feature to data sets from the object database
35 creating an authentication report
36 storing the authentication results together with further data for further evaluations

1. A three-dimensional printing method for the production of a product which is protected against forgery with at least one first security feature, consisting of an at least first feature substance, having the following method steps:
providing a digital 3D model of the product to be created,
providing the positions for the at least first feature substance for the at least first security feature,
providing the digital 3D model as a program code for controlling a 3D printer,
providing at least one first predetermined material for a 3D print,
providing at least one second predetermined material from the at least one feature substance or containing the at least one feature substance,
printing the product or building it up in a layer-wise fashion with the at least one first predetermined material,
making available the at least one feature substance at intended positions,
removing the product from thea, manufacturing facility or working space of the 3D printer and preparing the product for an intended use,
wherein the steps of printing or building up and of making available are combined through printing the product or building it up in a layer-wise fashion with the predetermined first material and second material at the intended positions in one combined printing step.

2. The method as claimed in claim 1, wherein providing the digital 3D model comprises producing the digital 3D model with a CAD method, a 3D scan or by a stored data set.

3. The method as claimed in claim 1, wherein providing the positions of the at least first feature substance comprises defining the spatial coordinates in the digital 3D model of the product.

4. The method as claimed in claim 1, wherein providing the digital 3D model comprises converting model data into the program code.

5. The method as claimed in claim 1, wherein relevant feature properties of the feature substance or substances and its or their positions in the product are stored in a product database.

6. The method as claimed in claim 1, wherein a control unit is provided, which predetermines the location or locations of the defined volume element or elements for each product produced taken from a group comprising a database, a random generator from a predetermined set of locations; and wherein the predetermined volume element or elements form at least partially surface sections of the product to be produced, and/or wherein the feature substance or substances are up-converters and/or down-converters.

7. The method as claimed in claim 5, wherein the product database is located in a decentralized fashion in a mobile or stationary device, or wherein the database is located in centralized fashion in a server, or wherein the database is located in the cloud and is accessible via different servers.

8. A method for authenticating a product protected against forgery with at least one first security feature, having the following method steps:
arranging the product on a holding apparatus,
positioning a detector device in one or more predetermined positions relative to the product,
registering relevant feature properties of thea feature substance or substances and its or their positions in the product,
comparing recorded data to data relating to feature properties and feature positions from a product database, and
creating a report relating to the result of the authentication.

9. The method as claimed in claim 8, wherein positioning the detector device is predetermined by data details from the product database.

10. The method as claimed in claim 8, wherein the report with respect to the authentication result is stored the product database together with location and the time point of the authentication process and with an identity of the examiner or of the detector device.

11. The method as claimed in claim 9, wherein the report comprises a comparison of the desired or actual values of the defined property of the feature substance or substances.

12. The method as claimed in claim 9, wherein, in the case of predetermined irradiation, an intensity of a sensor response of each defined volume element is measured and compared to corresponding desired values which are stored in the product database.

13. The method as claimed in claim 9, wherein the authentication result comprises a yes/no decision.

14. A set of at least two predetermined materials for the 3D print as claimed in claim 1, wherein at least one material comprises at least one feature substance.

15. The method as claimed in claim 8, wherein the data details are located in or on the product in encrypted form.

16. The method as claimed in claim 8, wherein the report with respect to the authentication is stored.
